(19) United States
(12) Patent Application Publication
(10) Pub. No.: US 2020/0168140 A1
(43) Pub. Date: May 28, 2020

(54) DISPLAY PANEL

(71) Applicant: AU Optronics Corporation, Hsin-Chu (TW)

(72) Inventors: Yi-Chiung CHEN, HSIN-CHU (TW); Hsiang-Sheng CHANG, HSIN-CHU (TW); Mao-Hsun CHENG, HSIN-CHU (TW)

(21) Appl. No.: 16/677,757

(22) Filed: Nov. 8, 2019

(30) Foreign Application Priority Data
Nov. 28, 2018 (TW) 107142535

(51) Int. Cl. G09G 3/00; G09G 3/3266; G09G 3/3291

(52) U.S. Cl. CPC G09G 3/006; G09G 3/3266; G09G 2320/046; G09G 2310/0286; G09G 3/3291

(57) ABSTRACT

A display panel has an active area and a peripheral area. The display panel includes N gate lines, N shift register, a plurality of pixel circuits, a switch circuit and a plurality of test pads. The switch circuit is arranged in the peripheral area, and electrically coupled to the N shift register, the N gate lines and the pixel circuits. The switch circuit is configured to receive a control signal and an enable signal, and pull down voltage level of N gate lines to a low voltage level. The test pads circuit are arranged in the peripheral area, and electrically coupled to the switch circuit and the pixel circuits. The test pads are configured to provide the control signal, the enable signal, a data signal and a reference signal.

### CROSS-REFERENCE TO RELATED APPLICATION

This application claims priority to Taiwanese Application Serial Number 107142535, filed on Nov. 28, 2018, which is herein incorporated by reference.

### BACKGROUND

### Field of Invention

The present invention relates to a display panel. More particularly, the present invention relates to a display panel for testing stage of burn-in.

### Description of Related Art

In order to improve the quality of displaying, the display panel of the organic light emitting diode usually needs to pass through a test stage such as burn in, cell test, and IC bonding. In the current panel detection mechanisms, it is usually to provide detection signals for organic light emitting diodes, respectively, and the testing pins will be cut off after the detection mechanism is executed, so that the display panel can be utilized to perform the display function. However, after the current panel detection mechanism is disconnected to the display panel, if the display panel still needs to perform other detections, it cannot re-perform the detection through the detection mechanism, so that it will caused inconvenience in subsequence detection.

### SUMMARY

The invention provides a display panel. The display panel includes an active area and a peripheral area, and the peripheral area is arranged in a side of the active area. The display panel includes N gate lines, N shift registers, a plurality of pixel circuits, a switch circuit and a plurality of test pads, wherein N is a positive integer. N shift registers are arranged in the peripheral area and are electrically coupled to the N gate lines, wherein each of the N shift registers is configured to output a gate signal. The plurality of pixel circuits are arranged in the active area and are electrically coupled to the N gate lines, and are configured to receive the gate signal, a data signal and a reference signal. The switch circuit is arranged in the peripheral area and is electrically coupled to the N shift registers, the N gate lines and the plurality of pixel circuits, and is configured to receive a control signal and an enable signal, and pull down voltage level of the N gate lines to a low voltage level. The plurality of test pads are arranged in the peripheral area, and are electrically coupled to the switch circuit and the plurality of pixel circuits, and configured to provide the control signal, the enable signal, the data signal and the reference signal.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a functional block diagram of a display panel according to one embodiment of the present disclosure.

FIG. 2 is a simplified schematic diagram of a pixel circuit according to one embodiment of the present disclosure.

FIG. 3 is a functional block diagram of a display panel according to another embodiment of the present disclosure.

FIG. 4 is a functional block diagram of a display panel according to another embodiment of the present disclosure.

FIG. 5 is a functional block diagram of a display panel according to another embodiment of the present disclosure.

### DETAILED DESCRIPTION

Reference will now be made in detail to the present embodiments of the invention, examples of which are illustrated in the accompanying drawings. Wherever possible, the same reference labels are used in the drawings and the description to refer to the same or like parts, components, or operations.

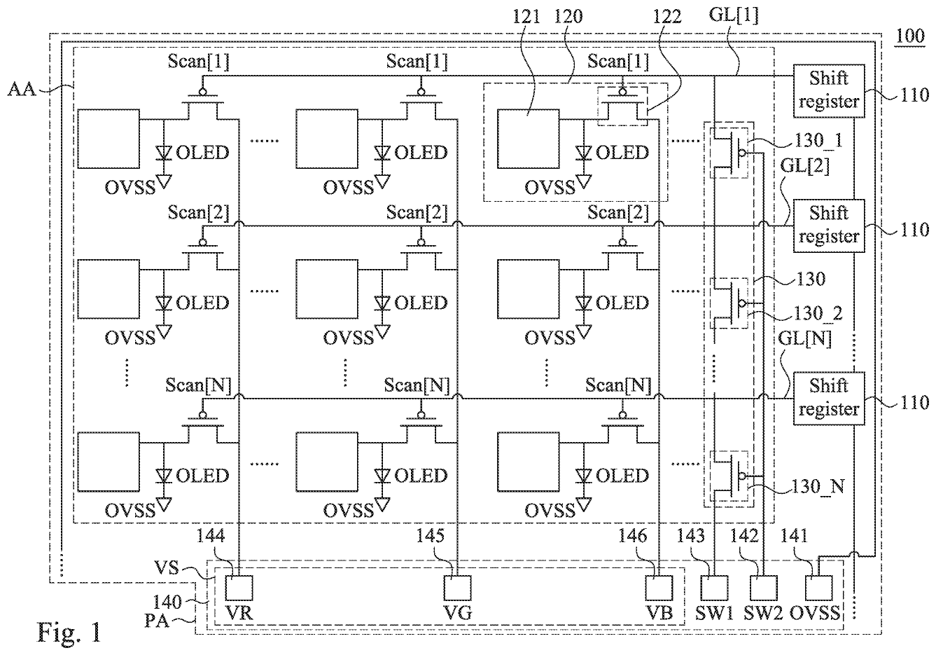

FIG. 1 is a functional block diagram of a display panel 100 according to one embodiment of the present disclosure. As shown in FIG. 1, the display panel 100 has an active area AA and a peripheral area PA, and the peripheral area PA is arranged in a side of the active area AA. The display panel 100 includes N gate lines GL[1]˜GL[N], N shift registers 110, a plurality of pixel circuits 120, a switch circuit 130 and a plurality of test pads 140, wherein N is a positive integer. The N shift registers 110 are arranged in the peripheral area PA and the N shift registers 110 are electrically coupled to the N gate lines GL[1]˜GL[N]. Each of the N shift registers 110 is configured to output a gate signal Scan[1]˜Scan[N]. The pixel circuits 120 are arranged in the active area AA and the pixel circuits 120 are electrically coupled to the N gate lines GL[1]˜GL[N]. The pixel circuits 120 are configured to receive the gate signal Scan[1]—Scan[N], a data signal VS and a reference signal OVSS.

Afterwards, the switch circuit 130 is arranged in the peripheral area PA and is electrically coupled to the N shift registers 110, the N gate lines GL[1]˜GL[N], and the pixel circuits 120. The switch circuit 130 is configured to receive a control signal SW2 and an enable signal SW1, and pull down voltage level of the N gate lines GL[1]˜GL[N] to a low voltage level. A plurality of test pads 140 are arranged in the peripheral area PA, and are electrically coupled to the switch circuit 130 and the pixel circuits 120. The test pads 140 are configured to provide the control signal SW2, the enable signal SW1, the data signal VS and the reference signal OVSS, wherein the data signal VS includes a first data signal VR, a second data signal VG and a third data signal VB.

As shown in FIG. 1, the test pads include a first test pad 141, a second test pad 142, a third test pad 143, a fourth test pad 144, a fifth test pad 145 and a sixth test pad 146. The first test pad 141 is electrically coupled to the pixel circuits 120, and the first test pad 141 is configured to provide the reference signal OVSS to the pixel circuits 120. The second test pad 142 is electrically coupled to the switch circuit 130, and the second test pad 142 is configured to provide the control signal SW2 to the switch circuit 130. The third test pad 143 is electrically coupled to the switch circuit 130, and the third test pad 143 is configured to provide the enable signal SW1 to the switch circuit 130. The fourth test pad 144 is electrically coupled to the pixel circuits 120, and the fourth test pad 144 is configured to provide the first data signal VR to the pixel circuits 120. The fifth test pad 145 is electrically coupled to the pixel circuits 120, and the fifth test pad 145 is configured to provide the second data signal VG to the pixel circuits 120. The sixth test pad 146 is electrically coupled to the pixel circuits 120, and the sixth test pad 146 is configured to provide the third data signal VB to the pixel circuits 120.

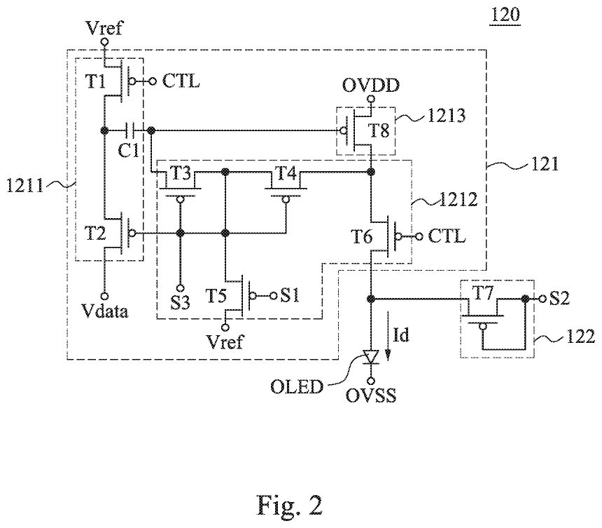

Reference is made to FIG. 2, which is a simplified schematic diagram of a pixel circuit according to one embodiment of the present disclosure. As shown in FIG. 2, the pixel circuit 120 of the present embodiment has eight transistors and one capacitor, i.e., an 8T1C structure. The pixel circuit 120 includes a driving circuit 121, a testing switch 122 and a light emitting diode OLED. The driving circuit 121 includes a writing circuit 1211, a compensation circuit 1212 and a driving transistor 1213. In the pixel circuit 120 of the present embodiment, the testing switch 122 will be operated during the testing stage, but the testing switch 122 will be utilized as the reset transistor T7 in the display stage, and the reset transistor T7 is configured to reset the anode terminal of the light emitting diode OLED.

Afterwards, the writing circuit 1211 includes transistor T1 and T2 and a capacitor C1. The writing circuit 1211 is configured to receive a pixel control signal CTL, a scan signal S3, a reference low voltage Vref and a data voltage Vdata. The compensation circuit 1212 includes transistor T3, T4, T5 and T6. The compensation circuit 1212 is configured to receive the pixel control signal CTL, a scan signals S1, the scan signal S3 and the reference low voltage Vref and generate the compensation voltage. The driving transistor 1213 includes transistor T8. The driving transistor 1213 is configured to receive a system high voltage OVDD and generate a driving current Id flowing through the light emitting diode OLED. The reset transistor T7 is configured to receive a scan signal S2 and reset the voltage level of the driving transistor 1213.

Reference is made to FIG. 1 and FIG. 2. The first node of the light emitting diode OLED is electrically coupled to the driving circuit 121, the second node of the light emitting diode OLED is electrically coupled to the first test pad 141. The first node of the testing switch 122 is electrically coupled to the first node of the light emitting diode OLED, and the second node of the testing switch 122 is electrically coupled to one of the fourth test pad 144, the fifth test pad 145 and the sixth test pad 146. The control node of the testing switch 122 is electrically coupled to one of the N gate lines GL[1]˜GL[N].

Afterwards, as shown in FIG. 1, the switch circuit 130 includes N switches 130_1˜130_N, the N switches 130_1˜130_N are electrically coupled to each other in series. For example, the first node of a first switch 130_1 is electrically coupled to the first gate line GL[1]; the second node of the first switch 130_1 is electrically coupled to the second gate line GL[2], and the control node of the first switch 130_1 is electrically coupled to the second test pad 142. The first node of a second switch 130_2 is electrically coupled to the second gate line GL[2]; the second node of the second switch 130_2 is electrically coupled to the third gate line GL[3], and the control node of the second switch 130_2 is electrically coupled to the second test pad 142. From the above, except for the Nth switch 130_N, the first switch 130_1 to the (N-1)th switch are electrically coupled between the gate line of the present stage and the gate line of the next stage. The first node of the Nth switch 130_N is electrically coupled to the Nth gate line GL[N]; the second node of the Nth switch 130_N is electrically coupled to the third test pad 143, and the control node of the Nth switch 130_N is electrically coupled to the second test pad 142.

Afterwards, the second test pad 142 is configured to output the control signal SW2 having a first low voltage level to enable the N switches 130_1˜130_N. The second node of the Nth switch 130_N is electrically coupled to the third test pad 143, and the enable signal SW1 inputted from the third test pad 143 has a second low voltage level. Thus, the N switches 130_1˜130_N are capable of pulling down the gate signal Scan[1]˜Scan[N] to the second low voltage level to enable the testing switch 122 of the pixel circuit 120, so that the data signal VS can be transmitted to the pixel circuit 120 to enable the light emitting diode OLED. Wherein the first low voltage level is lower than the second low voltage level and the difference between the first low voltage level and the second low voltage level is at least higher than the threshold voltage of the switches in the switch circuit 130.

Afterwards, in the display stage, the control signal SW2 outputted by the second test pad 142 switches to the high voltage level, so as to disable the N switches 130_1˜130_N. Thus, the switch circuit 130 will not be activated, and the testing switch 122 will transform to the operation of the reset transistor T7. The testing switch 122 is configured to reset the anode terminal of the light emitting diode OLED, and the pixel circuit 120 is configured to display according to the data voltage provided from a source driver (not shown in figure).

In the embodiment, the N switches 130_1˜130_N may be realized with N-type thin-film transistors or other various suitable N-type transistors, however, the disclosure is not limited thereto. The N switches 130_1˜130_N may be realized with P-type transistors, and the enable level of the N switches 130_1˜130_N will be changed to the positive voltage level.

As shown in FIG. 1, in the embodiment, the pixel circuits 120 will be divided into three groups, and the testing switch 122 of the first group of the pixel circuits 120 are electrically coupled to the fourth test pad 144, and configured to receive the first data signal VR. The testing switch 122 of the second group of the pixel circuits 120 are electrically coupled to the fifth test pad 145, and configured to receive the second data signal VG. The testing switch 122 of the second group of the pixel circuits 120 are electrically coupled to the sixth test pad 146, and configured to receive the third data signal VB.

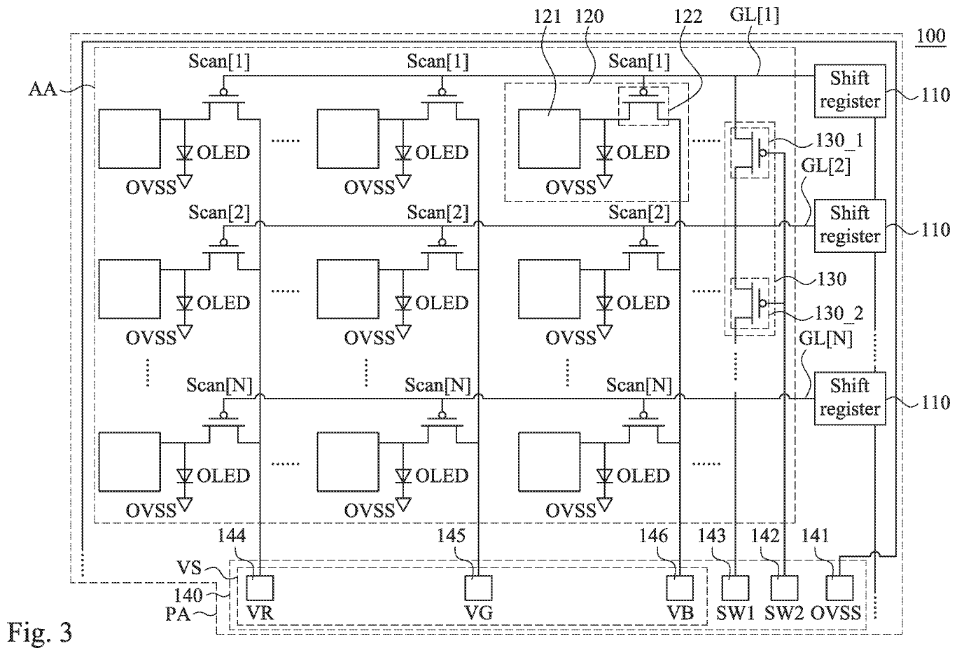

Afterwards, reference is made to FIG. 3, which is a functional block diagram of a display panel 300 according to another embodiment of the present disclosure. As shown in FIG. 3, the difference between the embodiment shown in FIG. 3 and the embodiment shown in FIG. 1 is that the switch circuit 130. The switch circuit 130 shown in FIG. 3 only includes N-1 switches 130_1˜130_N-1. The operation of the switch circuit 130 shown in FIG. 3 is the same as the operation of the switch circuit 130 shown in FIG. 1. When the switch circuit 130 is enabled by the control signal SW2, the enable signal SW1 is configured to pull down the gate signal Scan[1]-Scan[N] to the second low voltage level to enable the testing switch 122 of the pixel circuit 120. As shown in FIG. 3, first node of the (N-1)th switch 130_N-1 is electrically coupled to the (N-1)th gate line GL[N-1]; the second node of the (N-1)th switch 130_N-1 is electrically coupled to the Nth gate line GL[N], and the control node of the (N-1)th switch 130_N-1 is electrically coupled to the second test pad 142. In the embodiment, the utility of the Nth switch 130_N is that the gate signal Scan[N] of the Nth gate line GL[N] can be tested through the third test pad 143, and it does not need to utilize an additional test pad to test the gate signal.

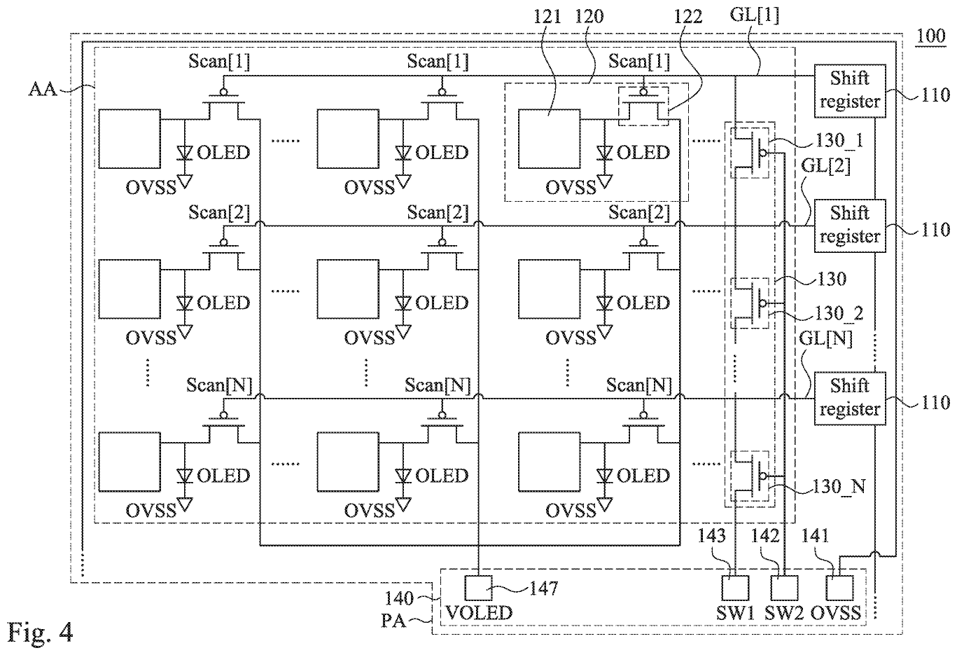

Reference is made to FIG. 4, which is a functional block diagram of a display panel 400 according to another embodiment of the present disclosure. As shown in FIG. 4, the difference between the embodiment shown in FIG. 4 and the embodiment shown in FIG. 1 is that the test pads 140. The test pads 140 shown in FIG. 4 include the first test pad 141, the second test pad 142, the third test pad 143 and the seventh test pad 147. The first test pad 141 is electrically coupled to the pixel circuits 120, and the first test pad 141 is configured to provide the reference signal OVSS to the pixel circuits 120. The second test pad 142 is electrically coupled to the switch circuit 130, and the second test pad 142 is configured to provide the control signal SW2 to the switch circuit 130. The third test pad 143 is electrically coupled to the switch circuit 130, and the third test pad 143 is configured to provide the enable signal SW1 to the switch circuit 130. The seventh test pad 147 is electrically coupled to the pixel circuits 120, and the seventh test pad 147 is configured to provide the data signal VOLED to the pixel circuits 120. The difference between the embodiment shown in FIG. 4 and the embodiment shown in FIG. 1 is that the pixel circuit 120 is divided into three groups and the test pads 140 are electrically coupled to the fourth test pad 144, the fifth test pad 145 and the sixth test pad 146, respectively. The second node of the test pads 140 shown in FIG. 4 are electrically coupled to the seventh test pad 147. In the embodiment shown in FIG. 4, the pixel circuit 120 only receives the data signal VOLED provided by the seventh test pad 147, and thus in the testing stage, it could not receive three different voltage levels shown in FIG. 1 (the first data signal VR, the second data signal VG and the third data signal VB) at the same time to enable the light emitting diode OLED.

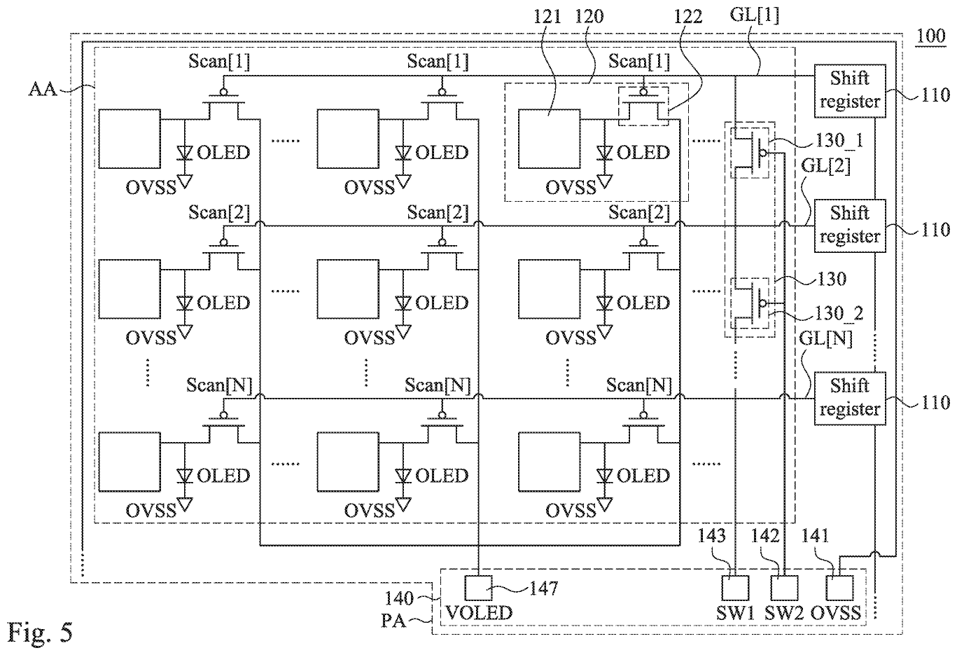

Reference is made to FIG. 5, which is a functional block diagram of a display panel 500 according to another embodiment of the present disclosure. As shown in FIG. 5, the difference between the embodiment shown in FIG. 5 and the embodiment shown in FIG. 4 is that the switch circuit 130. The switch circuit 130 shown in FIG. 5 only includes N-1 switches 130_1˜130_N-1. The operation of the switch circuit 130 shown in FIG. 5 is the same as the operation of the switch circuit 130 shown in FIG. 3. For the sake of brevity, those descriptions will not be repeated here.

In the current panel detection mechanisms, it is usually to provide detection signals for organic light emitting diodes, respectively, and the testing pins will be cut off after the detection mechanism is executed, so that the display panel can be utilized to perform the display function. However, after the current panel detection mechanism is disconnected to the display panel, if the display panel still needs to perform other detections, it cannot re-perform the detection through the detection mechanism, so that it will caused inconvenience in subsequence detection.

As can be appreciated from the foregoing embodiments, the display panel is capable of utilizing the resetting circuit structure of the anode terminal of the light emitting diode in the pixel circuit and additional switch circuit to enable the switch circuit. In the testing stage, this disclosure is utilized the current supplied by the power supply to enable the light emitting diode and there is no need additional fixture for burn-in. In the display stage, the switch circuit is disabled, the function of resetting the anode terminal of the light emitting diode OLED is still achieved. Therefore, the disclosure is capable of saving manufacturing cost and monitoring the performance of the component of the display panel.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The term “couple” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A display panel, the display panel comprises an active area and a peripheral area, and the peripheral area is arranged in a side of the active area, the display panel comprising:
N gate lines, wherein N is a positive integer;
N shift registers, arranged in the peripheral area and are electrically coupled to the N gate lines, wherein each of the N shift registers is configured to output a gate signal;
a plurality of pixel circuits, arranged in the active area and are electrically coupled to the N gate lines, and configured to receive the gate signal, a data signal and a reference signal;
a switch circuit, arranged in the peripheral area and is electrically coupled to the N shift registers, the N gate lines and the plurality of pixel circuits, and configured to receive a control signal and an enable signal, and pull down voltage level of the N gate lines to a low voltage level; and
a plurality of test pads, arranged in the peripheral area, and are electrically coupled to the switch circuit and the plurality of pixel circuits, and configured to provide the control signal, the enable signal, the data signal and the reference signal.

2. The display panel of claim 1, wherein the data signal comprises a first data signal, a second data signal and a third data signal.

3. The display panel of claim 2, wherein the plurality of test pads further comprising:
a first test pad, electrically coupled to the plurality of pixel circuits, and configured to provide the reference signal to the plurality of pixel circuits;
a second test pad, electrically coupled to the switch circuit, and configured to provide the control signal to the switch circuit;
a third test pad, electrically coupled to the switch circuit, and configured to provide the enable signal to the switch circuit;
a fourth test pad, electrically coupled to the plurality of pixel circuits, and configured to provide the first data signal to the plurality of pixel circuits;
a fifth test pad, electrically coupled to the plurality of pixel circuits, and configured to provide the second data signal to the plurality of pixel circuits; and
a sixth test pad, electrically coupled to the plurality of pixel circuits, and configured to provide the third data signal to the plurality of pixel circuits.

4. The display panel of claim 3, wherein the plurality of pixel circuits further comprising:
a driving circuit;
a light emitting diode, comprising a first node and a second node, wherein the first node is electrically coupled to the driving circuit, and the second node is electrically coupled to the first test pad; and
a testing switch, comprising a third node, a fourth node and a control node, wherein the third node is electrically coupled to the first node; the fourth node is electrically coupled to one of the fourth test pad, the fifth test pad, and the sixth test pad, and the control node is electrically coupled to one of the N gate lines.

5. The display panel of claim 3, wherein the switch circuit further comprising:
N-1 switches, electrically coupled to each other in series, wherein an (N-1)th switch comprise a first node, a second node and a control node, wherein the first node is electrically coupled to an (N-1)th gate line; the second node is electrically coupled to an Nth gate line, and the control node is electrically coupled to the second test pad.

6. The display panel of claim 5, wherein the switch circuit further comprising:
an Nth switch, comprising a first node, a second node and a control node, wherein the first node is electrically coupled to an Nth gate line; the second node is electrically coupled to the third test pad, and the control node is electrically coupled to the second test pad.

7. The display panel of claim 1, wherein the plurality of test pads further comprising:
a first test pad, electrically coupled to the plurality of pixel circuits, and configured to provide the reference signal to the plurality of pixel circuits;
a second test pad, electrically coupled to the switch circuit, and configured to provide the control signal to the switch circuit;
a third test pad, electrically coupled to the switch circuit, and configured to provide the enable signal to the switch circuit; and
a fourth test pad, electrically coupled to the plurality of pixel circuits, and configured to provide the data signal to the plurality of pixel circuits.

8. The display panel of claim 7, wherein the plurality of pixel circuits further comprising:
a driving circuit;
a light emitting diode, comprising a first node and a second node, wherein the first node is electrically coupled to the driving circuit, and the second node is electrically coupled to the first test pad; and
a testing switch, comprising a third node, a fourth node and a control node, wherein the third node is electrically coupled to the first node; the fourth node is electrically coupled to the fourth test pad, and the control node is electrically coupled to one of the N gate lines.

9. The display panel of claim 7, wherein the switch circuit further comprising:
N-1 switches, electrically coupled to each other in series, wherein an (N-1)th switch comprise a first node, a second node and a control node, wherein the first node is electrically coupled to an (N-1)th gate line; the second node is electrically coupled to an Nth gate line, and the control node is electrically coupled to the second test pad.

10. The display panel of claim 9, wherein the switch circuit further comprising:
an Nth switch, comprising a first node, a second node and a control node, wherein the first node is electrically coupled to an Nth gate line; the second node is electrically coupled to the third test pad, and the control node is electrically coupled to the second test pad.
